(19) United States
(12) Patent Application Publication
(10) Pub. No.: US 2021/0203671 A1
(43) Pub. Date: Jul. 1, 2021

(54) ADAPTIVE DOMAIN NAME SYSTEM

(71) Applicant: Hewlett-Packard Development Company, L.P., Spring, TX (US)

(72) Inventors: Adrian John Baldwin, Bristol (GB); Daniel Ellam, Bristol (GB); Jonathan Griffing, Bristol (GB); Stuart Lees, Bristol (GB)

(73) Assignee: Hewlett-Packard Development Company, L.P., Spring, TX (US)

(21) Appl. No.: 17/054,492

(22) PCT Filed: Sep. 18, 2018
(86) PCT No.: PCT/US2018/051540

§ 371 Date: Nov. 10, 2020

(51) Int. Cl. H04L 29/06; H04L 29/12; H04L 12/26

(52) U.S. Cl. CPC H04L 63/145; H04L 43/16; H04L 61/1511; H04L 63/1416

(57) ABSTRACT

In an example, there is provided a method for tracking domain name server (DNS) requests, wherein the method comprises determining whether a DNS request has resolved; and for each non-resolving DNS request decomposing the domain name of the request into multiple components, determining, for each component, a value of a metric representing the occurrence of the component in a corpus, generating a scaling factor for the request on the basis of the values for each component, and incrementing a count of the total number of non-resolving DNS requests by a scaled value on the basis of the scaling factor.

### BACKGROUND

Computing systems such as servers and personal computers are liable to be targeted by malicious software or “malware”. Malware programs cause significant disruption to users and businesses. In some cases, malware may be controlled remotely from a central command and control server. A command and control server sends instructions and receives outputs from the malware. To defend computers against this kind of malware, techniques may be employed such as throttling which restricts the ability of malware to connect to its command and control server.

### BRIEF DESCRIPTION OF THE DRAWINGS

Various features of certain examples will be apparent from the detailed description which follows, taken in conjunction with the accompanying drawings, which together illustrate, by way of example only, a number of features, wherein:

FIG. 1 is a block diagram of a computing system according to an example.

FIG. 2 shows a flow chart for tracking domain name requests on a computing system, according to an example.

FIG. 3 shows a processor a processor associated with a memory and comprising instructions for restricting domain name requests, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Computing systems are susceptible to being targeted by malicious software programs, also known as “malware”. Malware can have a devastating impact on a computing system to the point where the system becomes completely unusable. Malware comes in many different formats; however modern malware is often designed to exploit the fact that many modern computing systems are connected over the internet. This allows the author of the malware to remotely control the malware from a central command and control server.

A great amount of effort is placed in countering the threat posed by malware. For example, anti-virus software is now implemented on most systems. On the other hand, there is a continual struggle between malware authors and those seeking to counter their efforts.

Certain methods and systems employ “throttling” techniques. These techniques seek to restrict the ability of suspected malware to connect to their command and control server by exploiting the network connection of the target machine. For example, some systems may monitor the requests that are issued over the network between the target and the domain name server (DNS). Suspicious requests may indicate the presence of malware running on the machine.

Certain malware programs employ so called Domain Generation Algorithms (DGA). A DGA is an algorithm used by malware to try to ensure that the malware call find its command and control server even when defenders have previously identified and removed a command and control server. A DGA will generate a large set of DNS names. The DGA will often be seeded with the day or time so that each day (or selected time period) a new sequence of DNS names is generated.

The malware author understands the operation of the DGA algorithm and will choose one name at random. This name is registered and used to return the latest internet protocol (IP) address of their command and control server. Because a large number of potential DNS names are generated it is hard for a defender to pre-register all names in advance. Thus, a typical piece of malware using a DGA will generate a number of non-resolving DNS addresses that are random in nature, and then there will be one name that correctly resolves to the IP address of the command and control server.

Certain methods and systems employ DNS throttling. These methods provide a way of detecting and mitigating malware that uses a DGA to find or maintain contact with its command and control server. These methods use algorithms which count new, unique, non-resolving DNS queries. After an initial threshold is reached a throttling action is initiated and DNS resolutions are blocked unless the address has previously been seen and successfully resolved. According to examples, when an additional threshold is reached the detection is determined to be a robust detection of malware and appropriate remediation actions are applied. For example, in some cases a full reboot of the system to a clean state may be applied.

This method works well on networked printer platforms because users rarely type in DNS addresses and hence are unlikely to make repeated but different mistakes. Equally, printers are generally configured to go to a limited set of addresses and these will typically have been successfully resolved previously, hence the consequences of a false positive are relatively small.

Unfortunately, it is not sufficient in all scenarios to simply determine when the number of non-resolving DNS queries exceeds a threshold. In contrast to, for example, a networked printer, where a user rarely enters a domain name, the usage pattern of users on a general purpose computer may be unpredictable. Users may mis-type DNS addresses or they may go to broken web links which could lead to a threshold being reached.

One option to counteract the increased likelihood of false positives on general purpose computers is to increase the thresholds at which a throttling action is applied. Unfortunately, this leads to a delay in the detection of malware. Moreover, this leads to an increased likelihood that a DGA resolves early in its sequence before the threshold is reached and hence fail to be detected prior to connecting to the command and control server. In terms of the resulting throttling action this would restrict general browsing but would still give the user access to their normal web destinations such as email and commonly read websites.

The methods and systems described herein also employ a counter. In certain implementations the number of unique, non-resolving DNS name requests is counted. When they reach a given first threshold the throttling action is taken and then when they reach the second threshold a remediation threshold is reached. However, instead of incrementing a counter by 1 each time a unique non-resolving DNS request is received the counter is incremented by an amount scaled by an analysis of other available data.

The methods described herein determine a measure of how likely a given (non-resolving) DNS address is likely to come from a DGA. The increment is scaled between a minimum and maximum value. The threshold is subsequently reached at a faster pace when the non-resolving DNS requests look more suspicious. In one case, the manner in which the threshold is reached is determined by the function that computes an adaptive increment that is applied to the counter and is scaled between a minimum and maximum value. In another case, the threshold is adjusted.

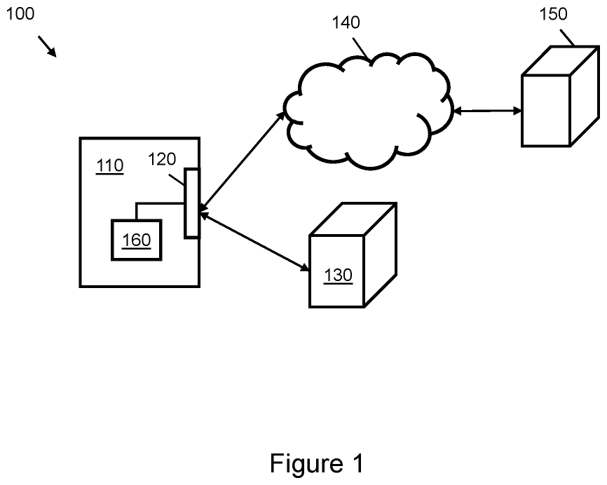

FIG. 1 shows a networked computing system 100 according to an example. The system shown in FIG. 1 comprises an apparatus 110. The apparatus 100 may be, for example a personal desktop computer, a server, a printer, or a mobile device. In the example shown in FIG. 1 the apparatus 110 comprises a networking interface 120. The networking interface 120 allows the device to communicate over a network using networking protocols such as the Internet Protocol (IP) and domain name resolution (DNS).

The system 100 shown in FIG. 1 further comprises a domain name server 130. The DNS server 130 contains a database of public IP addresses and their associated hostnames. The DNS server 130 is arranged to resolve, or translate, those common names to IP addresses as requested. The apparatus 100 is arranged to communicate with the domain name server to connect to particular address that a user has entered in the apparatus 100, for example, in an application with a user interface, such as a web browser.

When the apparatus 110 sends a request to the DNS server 130 then, in the case that the requested domain name successfully resolves, the DNS server 130 provides IP address to the apparatus 110. In the case that the request does not resolve the DNS server 130 will return a message to the apparatus 110 indicating that the request was not resolved.

According to examples described herein, the apparatus 110 is connected to a network 140, such as the internet. In FIG. 1 there is shown a web server 150. In the case where the user of the apparatus 110 wishes to connect to a web site hosted by the web server 150, the user will enter the domain name of the website to an application such as a web browser that runs on the apparatus 110. The request is communicated to the DNS server 130 which resolves the domain name and communicates the IP address of the web server to the apparatus 110. The apparatus 110 can then connect to the web server 140 over the network 120.

In the case that malware is executing on the apparatus 110, the malware may be controlled remotely by a command and control server. For example, in the case that the web server is a command and control server, the malware may try to connect the apparatus to the web server 110.

The apparatus 110 shown in FIG. 1 further comprises a throttling component 160. The throttling component 160 is communicatively coupled to the networking interface 120. According to examples, the throttling component 160 is arranged to respond to non-resolving DNS requests. The throttling component 160 decomposes the domain name of the request into multiple components. For example, in one case, the throttling component 160 may decompose the domain name into a sequence of bi-grams. Bi-grams are two letter combinations of letters in a piece of text. For example, for the DNS name:
Test.adrian.com
   the throttling component 160 would convert to the bi-grams:
Te, es, st, t., .a, ad, dr, ri, ia, an, .c, co, om

In a typical language certain bi-grams are more likely to occur than others. Thus, the throttling component 160 can evaluate the bi-grams that occur in the domain name to evaluate whether the domain name in the non-resolved request is likely to be from a human user, or from a non-human source, for example a domain generation algorithm that is being executed by malware on the apparatus.

According to examples the throttling component 160, is arranged to determine, for each component of the domain name, a value of a metric representing the occurrence of the component in a corpus of components. A corpus of components may be formed from a list of commonly occurring domain names. For example, in the case where the components are bi-grams, a training set based on a list of common domain names such as the Alexia million most popular domain names may be used. Bigrams for all of these domain names are evaluated and a frequency table comprising 256 rows by 256 columns for every ascii character, showing how often each bigram occurs is constructed. Then when a new non-resolving domain name is received the metric is calculated based on the frequency table and the bi-grams that occur in the domain name.

Once the throttling component 160, determines a value of a metric representing the occurrence of the component in a corpus for each component of the domain name, a scaling factor is generated for the request on the basis of the values of the metric for each component.

An example of the scaling factor that may be used is as follows. For each bi-gram in the domain name, a score may be computed using the following:
If (frequency[bigram]>threshold/count) then return 0;
Else. Return max (0, 1−(mult×frequency[bigram])/count)
   The above pseudocode determines that if the frequency of a bigram occurring in the domain name is above a threshold proportion of the total count, then return 0. Else, in the case that the frequency is below a threshold, return a value between 0 and 1, where the less common the bigram is, the closer the value is to 1.

The throttling component 160 is arranged to modify the total number of non-resolving DNS requests on the basis of the scaling factor for each component by determining an adaptive increment which depends on the scaling factors.

In the example described using bigrams, for each non-resolving DNS request, a sum of the scaling factors for all the bigrams is determined and divided by the number of bigrams. This value will have a minimum value of 0 and a maximum value of 1 so it is scaled between the minimum and maximum values. In certain cases the minimum value is greater than 0. This value forms an adaptive increment for the counter of the total number of non-resolving DNS requests.

According to examples described herein, the throttling component 160 is arranged to restrict DNS requests to the DNS server 130 in the event that the modified total number of non-resolving requests exceeds a threshold value.

In an alternative example, the likelihood of a particular string is determined based on the prior probabilities as per a maximal likelihood calculated from a corpus. Here, take a string
S=w₁ w₂ w₃ . . . wₙ.
   For example, with
S=“the”, w₁=t, w₁=h, w₃=e.
   The goal is to determine if the probability P(S) falls below a threshold then assume that “the” unpopular and scale the increment counter appropriately. The chain rule is applied so that
P(w₁, w₂, w₃, . . . wₙ)=P(wₙ| w₁, w₂, w₃, . . . wₙ₋₁)×P(wₙ₋₁|w₁, w₂, w₃, . . . wₙ₋₂) . . . ×P(w₁|word starts with w₁).
   By the Markov assumption that a letter depends on its previous letter and not those preceding this previous letter, this can be rewritten as
P(w₁, w₂, w₃, . . . wₙ)=P(wₙ|wₙ₋₁)P(wₙ₋₁|wₙ₋₂) . . . P(w₁|word starts with w₁).

To estimate this quantity, a frequency table is created as above and the maximal likelihood to calculate each of these terms is determined. For example, P(th)=p(hlt) which involves counting, for each occurrence of a tin the 1 million Alexa domains, how often it was followed by a h and dividing by the number of times a t appears. From a bi-gram table comprising a 27 by 26 matrix, with the extra row for starting with a particular letter, pick the correct row and column for the bi-gram and take the value as the numerator, then sum all the entries in the row and use this as the denominator. Repeating for all bi-grams and multiplying together gives an estimate of P(S). Again, a threshold may be used, which if P(S) is above, S may be treated as a normal bi-gram. The above methods may also be used with n-grams which generalizes the use of bi-grams.

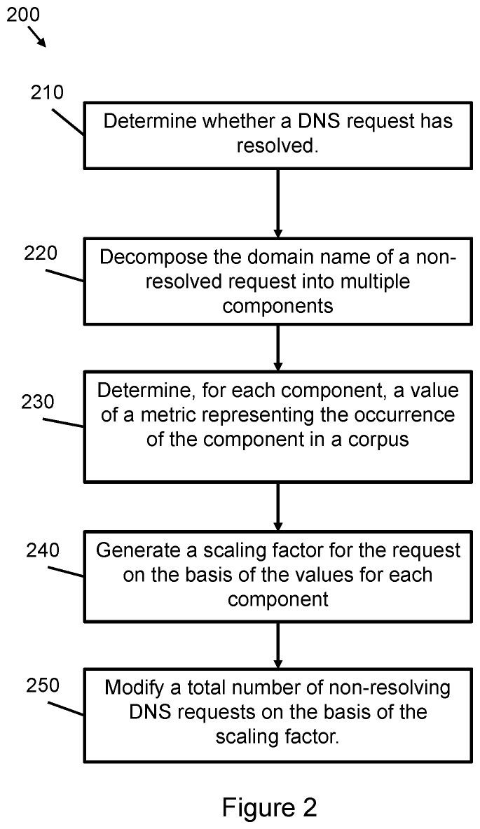

FIG. 2 is a flow diagram showing a method 200 of tracking domain name server requests according to an example. The method 200 may be implemented on the computing system 100 shown in FIG. 1. At block 210 it is determined whether a DNS request has resolved. This may be in the form of a notification from the DNS server 130, in the case the method 200 is implemented on the apparatus 110 shown in FIG. 1. At block 220, for each non-resolved DNS request, the method comprises, decomposing the domain name of the request into multiple components. As described previously, the components comprise in certain cases, n-grams of the domain name in the request.

At block 230 the method comprises determining, for each component, a value of a metric representing the occurrence of the component in a corpus. The corpus may comprise a list of commonly accessed domain names. In certain examples, the corpus also comprises the history of previously resolved domain names.

At block 240, a scaling factor is generated for the non-resolved DNS request on the basis of the values for each component. At block 250 the total number of non-resolving DNS requests is modified on the basis of the scaling factor.

According to examples described herein the method 200 may further comprise restricting DNS requests in the event that the modified total number of non-resolving requests exceeds a threshold value. This may also be implemented on the throttling component of the apparatus 110 shown in FIG. 1.

According to examples, the scaling factor of a component of a non-resolved request is a minimum value if the occurrence of the component in the corpus is above a threshold value. This is likely to occur if the component forms part of regular language, for example. In certain cases, the scaling factor for a component is a value between a minimum and a maximum value that inversely depends on the occurrence of the component in the corpus. In particular, if the component occurs frequently in the corpus, the scaling factor is likely to be low or the minimum.

According to examples described herein the method 200 may comprise applying certain mitigation actions in the case that it is suspected that DNS requests are being made as a result of a domain generation algorithm (DGA). In this case, the likelihood that the apparatus has become infected with malware is high. A mitigation action may comprise, isolating components of the apparatus 110. Alternatively, the apparatus is reset to a previously known safe state.

DGAs tend to have particular patterns of timing in how DNS requests are generated. For example, requests may be generated at fairly regular time intervals or as two requests followed by a regular time period. According to examples described herein, the method 200 further comprises estimating over time how well one of these patterns is being matched by storing the time intervals between non-resolving requests and reporting the time intervals between the best fit of these two timing models. In this case variances below a given threshold would map to a maximum score and as the variance rise above a second threshold they would map to the minimum score. This can also form the basis for determining whether to apply throttling to DNS requests from the apparatus.

The methods and systems described herein provide an enhancement for to detections of malware and false positive rates. The presently disclosed methods and systems perform better on real general purpose computing systems in contrast to systems in which DNS requests are predictable. Advantageously, the methods and systems disclosed herein do not penalise users unnecessarily for mistyping errors in DNS requests but still protect users' systems from malicious software.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

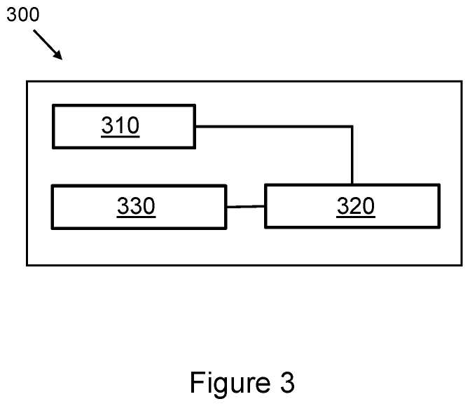

FIG. 3 shows an example of a processor 310 associated with a memory 320. The memory 320 comprises computer readable instructions 330 which are executable by the processor 310. The instructions 330 comprise instruction to: parse a non-resolving DNS request, generate a scaling factor, on the basis of the occurrence of n-grams in the domain name of the non-resolving DNS request, modify a total number of non-resolving DNS requests on the basis of the scaling factor, and restrict further DNS requests in response to the modified total number exceeding a threshold value.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for tracking domain name server (DNS) requests, the method comprising:
determining whether a DNS request has resolved; and
for each non-resolving DNS request:
decomposing the domain name of the request into multiple components;
determining, for each component, a value of a metric representing the occurrence of the component in a corpus;
generating a scaling factor for the request on the basis of the values for each component; and
incrementing a count of the total number of non-resolving DNS requests by a scaled value on the basis of the scaling factor.

2. The method of claim 1, comprising restricting DNS requests in the event that the total number of non-resolving requests exceeds a threshold value.

3. The method of claim 1, wherein the components and corpus comprise n-grams.

4. The method of claim 1, wherein the scaling factor for a component is a minimum value if the occurrence of the component in the corpus is above a threshold value.

5. The method of claim 1, wherein the scaling factor for a component is a value between a minimum value and a maximum value that inversely depends on the occurrence of the component in the corpus.

6. The method of claim 1, wherein the corpus comprises domain names of resolved DNS requests.

7. The method of claim 2, comprising identifying the source of non-resolving DNS requests as a domain generation algorithm (DGA), in response to the modified total number of non-resolving requests exceeding a further threshold value.

8. The method of claim 7 comprising, performing mitigation actions in response to identifying the source of non-resolving DNS requests as a DGA.

9. The method of claim 1, wherein the values of the metric for the components of a non-resolving request are determined as a probability based on the occurrence of the components in the corpus.

10. The method of claim 9, wherein the scaling factor is determined on the basis of the product of values for the components in the domain name.

11. The method of claim 1, further comprising, for each non-resolving DNS request, determining if the variation between the timing of the non-resolving request and previous non-resolving requests falls below a threshold value and, in response, restricting further DNS requests.

12. An apparatus, comprising:
a networking interface arranged to communicate with a domain name server (DNS);
a throttling component communicatively coupled to the networking interface and arranged to, in response to a failed DNS request:
identify portions in the domain name of the failed DNS request;
for each portion, evaluate a metric representative of an occurrence of the portion in a database; and
generate a score for the failed DNS request on the basis of the metric.

13. The apparatus of claim 12 wherein the throttling component is arranged to restrict DNS requests for the apparatus in response to a cumulative score for all failed DNS requests exceeding a threshold value.

14. The apparatus of claim 13, wherein the throttling component is arranged to restrict DNS requests on the basis of an evaluation of the time between respective failed DNS requests.

15. A non-transitory machine-readable storage medium encoded with instructions executable by a processor, to:
parse a non-resolving DNS request:
generate a scaling factor, on the basis of the occurrence of n-grams in the domain name of the non-resolving DNS request;
modify a total number of non-resolving DNS requests on the basis of the scaling factor; and
restrict further DNS requests in response to the modified total number exceeding a threshold value.
